(19) United States
(12) Patent Application Publication
(10) Pub. No.: US 2016/0339456 A1
(43) Pub. Date: Nov. 24, 2016

(54) POKING-ROD TYPE MULTI-FUNCTION SHOWER ARM AND METHOD OF MANUFACTURING THE SAME

(71) Applicant: Xiamen Runner Industrial Corporation, Xiamen (CN)

(72) Inventors: Wen-Kun Lin, Xiamen (CN); Yuan-shan Liang, Xiamen (CN); Sheng-chao Dai, Xiamen (CN)

(21) Appl. No.: 15/152,299

(22) Filed: May 11, 2016

(30) Foreign Application Priority Data
May 18, 2015 (CN) 201510251751.5

(51) Int. Cl. B05B 1/30; E03C 1/02; B05B 1/18

(52) U.S. Cl. CPC B05B 1/3026; B05B 1/185; E03C 1/025

(57) ABSTRACT

A poking-rod type multi-function shower arm comprises: a shower arm main body, including: a water output end, at least two water output ends, disposed around an outer wall of a water output chamber in the shower arm main body, and formed with an angle to each other, while connected and communicating with the water output chamber; a tight seal plug, disposed in the water output chamber, and used to block respective water output ends; a swing rod, sleeved in a center of the tight seal plug, and extended outside the water output chamber, to drive the tight seal plug to move, so as to close the water output end, to prevent it from outputting water.

### BACKGROUND OF THE INVENTION

Field of the Invention

The present invention relates to a multi-function shower arm, and in particular to a poking-rod type multi-function shower arm and method of manufacturing the same, used in bathing and sanitary equipment.

The Prior Arts

Presently on the market, a shower arm is used only for transporting water when taking a shower, while the devices used for controlling shower water output is placed elsewhere the shower arm, such as in a mixed valve, and that could require built-in design. As such, the built-in design for a combined shower and shower head is important. However, it is essential that a water output device is designed to have its own integrated water output control elements. Yet, presently, user has to purchase water output control device separately for a shower head and a shower, and that could incur additional cost and cause quite inconvenience for the user.

As such, presently, a shower arm is only designed to have water transport function, while shower water output control device must be put in a separate place, that could cause inconvenience in application. Therefore, the design and performance of the shower arm is not quite satisfactory, and it leaves much room for improvement.

### SUMMARY OF THE INVENTION

In view of the problems and drawbacks of the prior art, the present invention provides a poking-rod type multi-function shower arm and method of manufacturing the same, to overcome the shortcomings of the prior art.

The present invention provides a poking-rod type multi-function shower arm, comprising: a shower arms main body, a tight seal plug, and a swing rod. Wherein, the shower arm main body includes: a water output end; at least two water output ends, disposed around an outer wall of a water output chamber in the shower arm main body, and formed with an angle to each other, while connected and communicating with the water output chamber. The tight seal plug is disposed in the water output chamber, and is used to block the respective water output ends. The swing rod is sleeved in a center of the tight seal plug, and is extended outside the water output chamber, to drive the tight seal plug to move, so as to close the water output end, to prevent it from outputting water.

In an aspect of the present invention, the water output ends include a shower water output end, and a shower head water output end.

In another aspect of the present invention, the present invention further includes a slide block and an inner tank. Wherein, the slide block having its inside provided with a tight seal plug, a side of the tight seal plug facing the two water output ends is provided with a protrusion portion, used to block the water output end, and the protrusion portion is disposed to penetrate a through hole at a side of the slide block, to protrude into outside. The inner tank is disposed in the water output chamber, a bottom portion of the inner tank is provided with a guide slot, and one end of the swing rod facing the water output chamber is inserted into the guide slot, while a terminal of the end is provided with a flange for preventing the swing rod from slipping out of the guide slot.

In a further aspect of the present invention, the present invention further includes an elastic bead, that is provided inside the slide block facing a bottom portion of the inner tank. The bottom portion of the inner tank is provided with an indent portion to restrict position of the elastic beads.

In yet another aspect of the present invention, the present invention further includes a left end cap and a right end cap, that are disposed respectively at two sides of the water output chamber, for closing the water output chamber, the left end cap and the right end cap are fixed onto the inner tank through cooperation of a fastening slot and a pin.

In an aspect of the present invention, the present invention further includes a fix cap and a face cap, disposed between the left end cap and the slide block, and the fix cap and the face cap are connected through threads. One end of the swing rod is disposed to penetrate through the fix cap, the face cap, and the left end cap, and is inserted into a poking handle.

In another aspect of the present invention, in a middle of the swing rod is provided with ball shape portion, which is fastened onto the face cover.

In a further aspect of the present invention, the present invention further includes a tight seal ring, disposed each in the inner tank and the water output chamber.

The present invention also provides a poking-rod type multi-function shower arm manufacturing method, comprising following steps:

(1) providing a shower arm main body and an inner tank contained therein, to form a guide slot and an indent portion at a bottom portion of the inner tank, providing and installing a tight seal plug based on an angle of a shower water output end and a shower head water output end, such that the tight seal plug is provided with a protrusion portion facing the shower water output end and the shower head water output end;

(2) providing an elastic bead and a slide block, to put the tight seal plug and elastic beads into the slide block, and then placing the slide block into the inner tank to achieve fixing;

(3) providing a swing rod, putting the swing rod penetrating the slide block and the tight seal plug, with its other end connected with a guide slot to realize connection in a sliding manner;

(4) placing the inner tank having installed the slide block, the tight seal plug, and the swing rod into the water output chamber of the shower arm main body, while a tight seal ring is each provided in the inner tank and an inner wall of the water output chamber; and

(5) closing the water output chamber, and installing a poking handle on the outer side of swing rod, to facilitating poking.

Compared with the Prior Art, the present invention has the advantages that, it combines the conventional shower arm and the water splitter together into one piece. Wherein, a poking mechanism is used to achieve the water control function for the shower arm and a water splitter. It is simple in construction, compact in appearance, and it solves the problem of the user having to purchase and install the above two pieces separately.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is an exploded view of a poking-rod type multi-function shower arm according to an embodiment of the present invention;

FIG. 2 is a schematic diagram showing a structure of a slide block in cooperation with a tight seal plug according to an embodiment of the present invention;

FIG. 3 is a schematic diagram of a poking-rod type multi-function shower arm after assembly according to an embodiment of the present invention;

FIG. 4 is a schematic diagram of a structure of an inner tank according to an embodiment of the present invention;

FIG. 5 is a schematic diagram of a poking-rod type multi-function shower arm in application (the shower water output end closed) according to an embodiment of the present invention;

FIG. 6 is a schematic diagram of a poking-rod type multi-function shower arm in application (both the shower water output end and the shower head water output end are opened) according to another embodiment of the present invention; and

FIG. 7 is a schematic diagram of a poking-rod type multi-function shower arm in application (the shower head water output end closed) according to a further embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

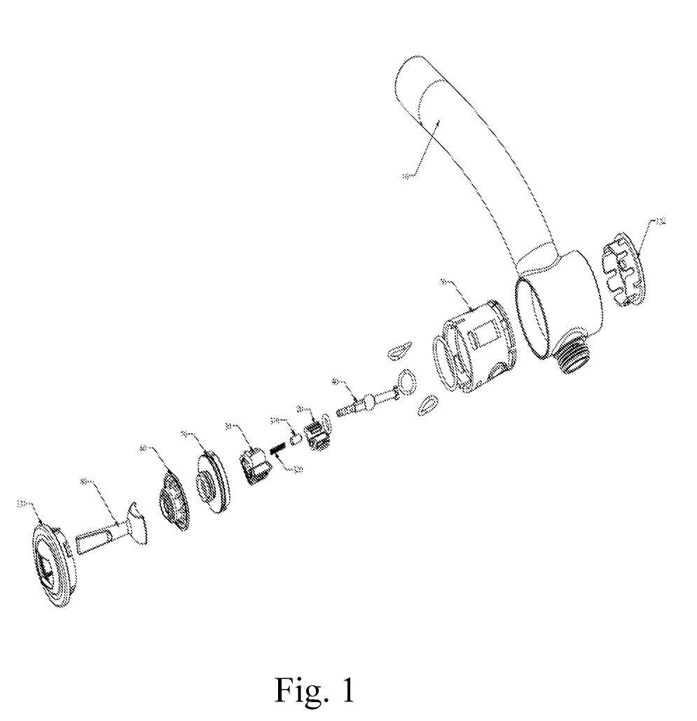

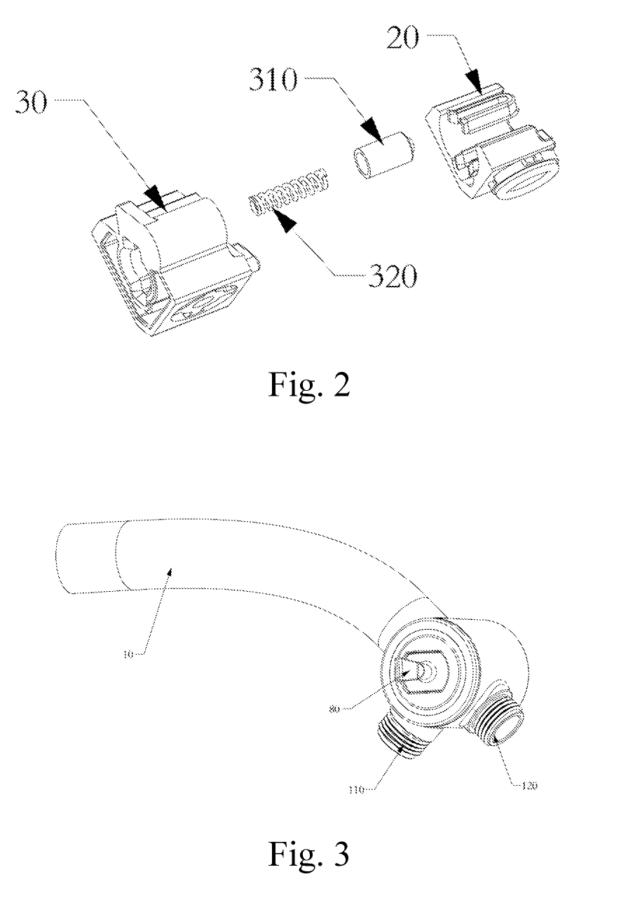

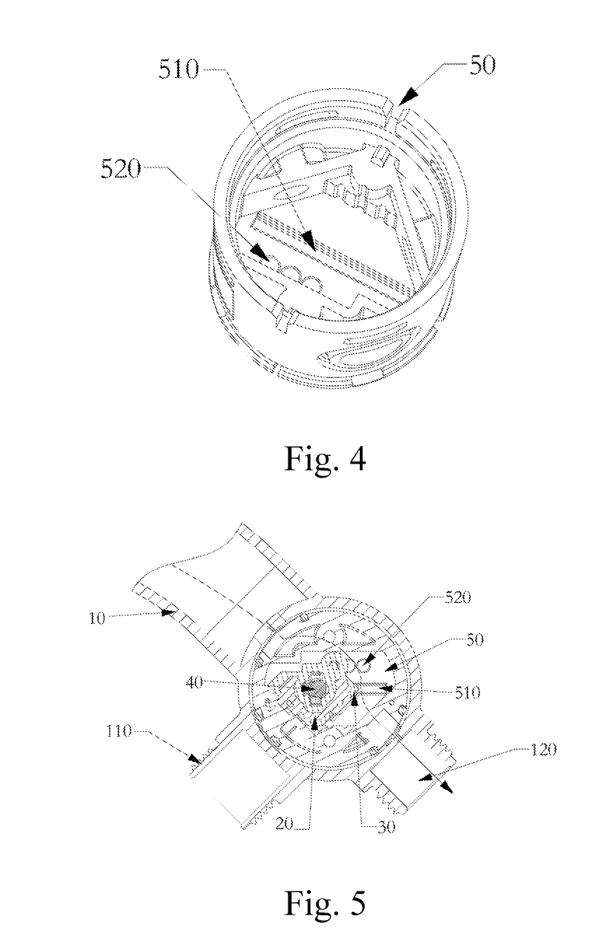

Refer to FIGS. 1 to 7 respectively for an exploded view of a poking-rod type multi-function shower arm according to an embodiment of the present invention; a schematic diagram showing a structure of a slide block in cooperation with a tight seal plug according to an embodiment of the present invention; a schematic diagram of a poking-rod type multi-function shower arm after assembly according to an embodiment of the present invention; a schematic diagram of a structure of an inner tank according to an embodiment of the present invention; a schematic diagram of a poking-rod type multi-function shower arm in application (the shower water output end closed) according to an embodiment of the present invention; a schematic diagram of a poking-rod type multi-function shower arm in application (both the shower water output end and the shower head water output end are opened) according to another embodiment of the present invention; and a schematic diagram of a poking-rod type multi-function shower arm in application (the shower head water output end closed) according to a further embodiment of the present invention.

As shown in FIGS. 1 to 7, the present invention provides a poking-rod type multi-function shower arm, comprising: a shower arm main body 10, a tight seal plug 20, and a swing rod 40. Wherein, the shower arm main body 10 includes: a water output end; at least two water output ends 110,120, disposed around an outer wall of a water output chamber 130 in the shower arm main body 10, and formed with an angle to each other, while connected and communicating with the water output chamber 130. The tight seal plug 20 is disposed in the water output chamber 130, and is used to block the respective water output ends. The swing rod 40 is sleeved in a center of the tight seal plug 20, and is extended outside the water output chamber 130, to drive the tight seal plug 20 to move, so as to close the water output end, to prevent it from outputting water.

In an embodiment of the present invention, the water output ends include a shower water output end 110, and a shower head water output end 120.

In an embodiment of the present invention, the present invention further includes a slide block 30 and an inner tank 50. Wherein, the slide block 30 having its inside provided with a tight seal plug 20, a side of the tight seal plug 20 facing the two water output ends is provided with a protrusion portion, used to block the water output end, and the protrusion portion is disposed to penetrate a through hole at a side of the slide block 30, to protrude into outside. The inner tank 50 is disposed in the water output chamber 130, a bottom portion of the inner tank 50 is provided with a guide slot, and one end of the swing rod 40 facing the water output chamber 130 is inserted into the guide slot, while a terminal of the end is provided with a flange for preventing the swing rod 40 from slipping out of the guide slot.

In an embodiment of the present invention, the present invention further includes an elastic bead 310, that is provided inside the slide block 30 facing a bottom portion of the inner tank 50, and is formed by a bead 310 and a spring 320. The spring 320 exerts a force constantly on the bead 310. Under the action of the swing rod 40, an indent portion 520 provided at the bottom portion of the inner tank 50 is sled and moved to restrict position of the elastic beads 310.

In an embodiment of the present invention, the present invention further includes a left end cap 131 and a right end cap 132, that are disposed respectively at two sides of the water output chamber 130, for closing the water output chamber 130, the left end cap 131 and the right end cap 132 are fixed onto the inner tank 50 through cooperation of a fastening slot and a pin.

In an embodiment of the present invention, the present invention further includes a fix cap 60 and a face cap 70, disposed between the left end cap 131 and the slide block 30, and the fix cap 60 and the face cap 70 are connected through threads. One end of the swing rod 40 is disposed to penetrate through the fix cap 60, the face cap 70, and the left end cap 131, and is inserted into a poking handle 80.

In an embodiment of the present invention, in a middle of the swing rod 40 is provided with ball shape portion, which is fastened onto a face cover 70.

In an embodiment of the present invention, the present invention further includes a tight seal ring, disposed each in the inner tank 50 and the water output chamber 130.

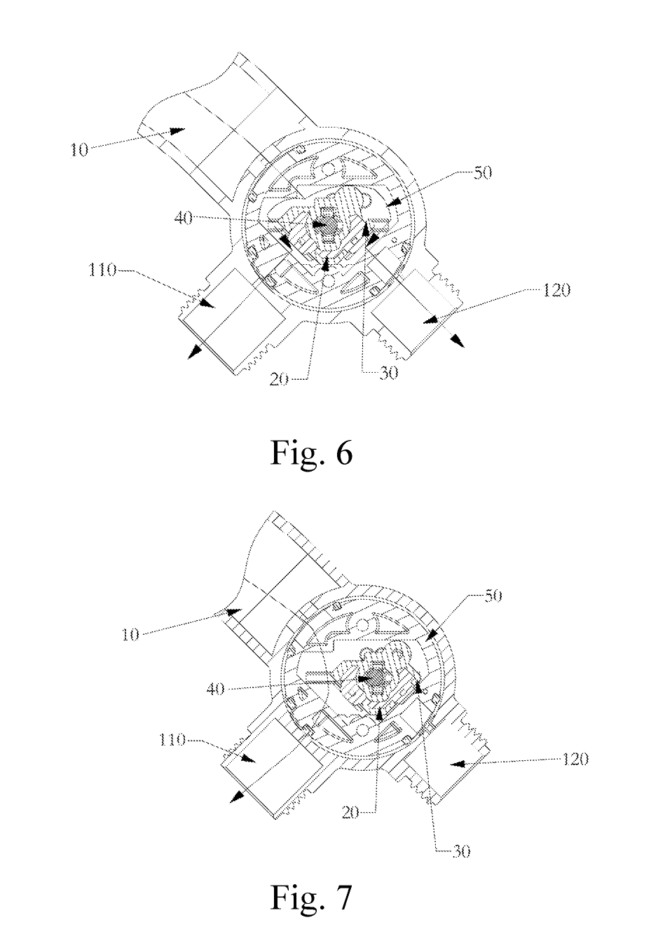

In application, as shown in FIGS. 5 to 7, when the swing rod 40 is moved to the leftmost side through a slide slot, the slide block 30 and the tight seal plug 20 are moved to block the shower water output end 110, so that water flowed to the shower head water output end 120 (FIG. 5). When the swing rod 40 is moved to a middle position, both the shower water output end 110 and the shower head water output end 120 output water at the same time (FIG. 6). When the swing rod 40 is moved to the rightmost side, the shower water output end 110 is connected, while the shower head water output end 120 is blocked by the tight seal plug 20 (FIG. 7). In the process mentioned above, the position restriction effected by the bead 310 and indent portion 520 is used to control the sliding movement mentioned above.

The present invention also provides a poking-rod type multi-function shower arm manufacturing method, comprising following steps:

(1) providing a shower arm main body 10 and an inner tank 50 contained therein, to form a guide slot and an indent portion at a bottom portion of the inner tank 50, providing and installing a tight seal plug 20 based on an angle of a shower water output end 110 and a shower head water output end 120, such that the tight seal plug 20 is provided with a protrusion portion facing the shower water output end 110 and the shower head water output end 120;

(2) providing an elastic bead 310 and a slide block 30, to put the tight seal plug 20 and elastic beads 310 into the slide block 30, and then placing the slide block 30 into the inner tank 50 to achieve fixing;

(3) providing a swing rod 40, putting the swing rod 40 penetrating the slide block 30 and the tight seal plug 20, with its other end connected with a guiding slot to realize connection in a sliding manner;

(4) placing the inner tank 50 having installed the slide block 30, the tight seal plug 20, and the swing rod 40 into the water output chamber 130 of the shower arm main body 10, while a tight seal ring is each provided in the inner tank 50 and an inner wall of the water output chamber 130; and

(5) closing the water output chamber 130, and installing a poking handle (80) on the outer side of swing rod 40, to facilitating poking.

Compared with the Prior Art, the present invention has the advantages that, it combines the conventional shower arm and the water splitter together into one piece. Wherein, a poking mechanism is used to achieve the water control for the shower arm and a water splitter. It is simple in construction, compact in appearance, and it solves the problem of the user having to purchase and install the above two pieces separately.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A poking-rod type multi-function shower arm, comprising:
a shower arm main body, including:
a water output end, and
at least two water output ends, disposed around an outer wall of a water output chamber in the shower arm main body, and formed with an angle to each other, while connected and communicating with the water output chamber;
a tight seal plug, disposed in the water output chamber, and used to block the respective water output ends; and
a swing rod, sleeved in a center of the tight seal plug, and extended outside the water output chamber, to drive the tight seal plug to move, so as to close the water output end, to prevent it from outputting water.

2. The poking-rod type multi-function shower arm as claimed in claim 1, wherein the water output ends include a shower water output end, and a shower head water output end.

3. The poking-rod type multi-function shower arm as claimed in claim 1, further comprising:
a slide block, with its inside provided with the tight seal plug, a side of the tight seal plug facing the two water output ends being provided with a protrusion portion, used to block the water output end, with the protrusion portion disposed to penetrate a through hole at a side of the slide block, to protrude into outside; and
an inner tank, disposed in the water output chamber, a bottom portion of the inner tank being provided with a guide slot, and one end of the swing rod facing the water output chamber being inserted into the guide slot, while a terminal of the end is provided with a flange for preventing the swing rod from slipping out of the guide slot.

4. The poking-rod type multi-function shower arm as claimed in claim 3, further comprising: an elastic bead, provided inside the slide block and facing a bottom portion of the inner tank, the bottom portion of the inner tank being provided with an indent portion to restrict position of the elastic beads.

5. The poking-rod type multi-function shower arm as claimed in claim 3, further comprising: a left end cap and a right end cap, disposed respectively at two sides of the water output chamber, for closing the water output chamber, with the left end cap and the right end cap fixed onto the inner tank through cooperation of a fastening slot and a pin.

6. The poking-rod type multi-function shower arm as claimed in claim 5, further comprising: a fix cap and a face cap, disposed between the left end cap and the slide block, with the fix cap and the face cap connected through threads, one end of the swing rod being disposed to penetrate through the fix cap, the face cap, and the left end cap, and being inserted into a poking handle.

7. The poking-rod type multi-function shower arm as claimed in claim 6, wherein a middle of the swing rod is provided with a ball shape portion, fastened onto the face cover.

8. The poking-rod type multi-function shower arm as claimed in claim 3, further comprising: a tight seal ring, disposed each in the inner tank and the water output chamber.

9. A manufacturing method used to produce a poking-rod type multi-function shower arm as claimed in claim 1, comprising following steps:
(1) providing a shower arm main body and an inner tank contained therein, to form a guide slot and an indent portion at a bottom portion of the inner tank, providing and installing a tight seal plug based on an angle of a shower water output end and a shower head water output end, the tight seal plug being provided with a protrusion portion facing the shower water output end and the shower head water output end;
(2) providing an elastic bead and a slide block, to put the tight seal plug and elastic beads into the slide block, and then placing the slide block into the inner tank to achieve fixing;
(3) providing a swing rod, putting the swing rod penetrating the slide block and the tight seal plug, with its other end connected with a guide slot to realize connection in a sliding manner;
(4) placing the inner tank having installed the slide block, the tight seal plug, and the swing rod into the water output chamber of the shower arm main body, while a tight seal ring is each provided in the inner tank and an inner wall of the water output chamber; and
(5) closing the water output chamber, and installing a poking handle on an outer side of the swing rod, to facilitate poking.
